(19) United States
(12) Patent Application Publication
(10) Pub. No.: US 2018/0038234 A1
(43) Pub. Date: Feb. 8, 2018

(54) TURBOMACHINE COMPONENT WITH FLOW GUIDES FOR FILM COOLING HOLES IN FILM COOLING ARRANGEMENT

(71) Applicant: Siemens Aktiengesellschaft, Munich (DE)

(72) Inventor: John David Maltson, Skellingthorp (GB)

(73) Assignee: Siemens Aktiengesellschaft, Munich (DE)

(21) Appl. No.: 15/664,388

(22) Filed: Jul. 31, 2017

(30) Foreign Application Priority Data
Aug. 5, 2016 (EP) 16183035.1

(51) Int. Cl. F01D 5/18; F01D 25/12; F01D 9/04

(52) U.S. Cl. CPC F01D 5/187; F01D 9/041; F01D 25/12; F05D 2220/32; F05D 2260/201; F05D 2260/202; F05D 2260/221

(57) ABSTRACT

A turbomachine component having film cooling arrangement includes a cooling passage, an external wall having an outer surface to be positioned in a hot gas path and an inner surface forming a part of the cooling passage, film cooling holes formed through the external wall, and a flow guide arrangement having a flow guide corresponding to one of the film cooling holes. Each film cooling hole has an inlet at the inner surface and an outlet at the outer surface. The inlet receives a cooling fluid from the cooling passage and the outlet releases it over the outer surface. The flow guide positioned at the inlet of the corresponding film cooling hole on the inner surface redirects within the cooling passage a flow of the cooling fluid such that the flow makes a U-turn before entering the inlet of the corresponding film cooling hole in a reversed flow.

### CROSS REFERENCE TO RELATED APPLICATIONS

This application claims the benefit of European Application No. EP16183035 filed 5 Aug. 2016, incorporated by reference herein in its entirety.

### FIELD OF INVENTION

The present invention relates to turbomachine components having film cooling arrangements, such as a vane or a blade, for gas turbine engines.

### BACKGROUND OF INVENTION

To effectively use cooling fluid, e.g. cooling air, for cooling of gas turbine engine components is a constant challenge and an important area of interest in gas turbine engine designs. For cooling different components of a gas turbine engine different cooling strategies are used, for example for cooling turbomachine components that have an external wall that is exposed to hot gases when the turbomachine is operational, such as an aerofoil wall or a platform of a vane or a blade in turbine section, conventional design uses various ways including circulation of cooling fluid through cooling passages arranged within the turbomachine component and subsequently exiting the cooling fluid though film cooling holes located on the external wall of the turbomachine component to form a film of cooling fluid on an outer surface of the external wall to protect the turbomachine component from high temperatures of the hot gases when the gas turbine engine is operational.

Furthermore, an inner surface of the external wall, i.e. surface that is not exposed to the hot gases, generally forms part of the cooling passages, for example forms a wall of the cooling passage, and flow of the cooling fluid over and in contact with the inner surface before being exited through the film cooling holes results in cooling of the inner surface of the external wall and thus in cooling of the turbomachine component.

The film cooling holes run through the external walls i.e. the cooling holes have an inlet at the inner surface of the external wall and an outlet at the outer surface of the external wall. The cooling fluid flowing in the cooling passages running over the inner surface of the external wall enters the inlet and goes out of the outlet to form the film of the cooling fluid. The film cooling holes are spaced apart over the external wall and this leaves regions of the inner surface between the inlets of the film cooling holes that do not get effectively cooled because adequate amount of the cooling fluid does not flow over these regions as most of the cooling fluid enters the inlets of the film cooling holes before the cooling fluid could flow further to regions of the inner surface between the inlets of the film cooling holes and to regions of the inner surface downstream of the inlets of the film cooling holes, when viewed in a direction of flow of the cooling fluid within the cooling passage.

Thus there is a need to provide a technique for turbomachine components having film cooling arrangements in which the regions of the inner surface between the inlets of the film cooling holes and the regions of the inner surface downstream of the inlets of the film cooling holes, when viewed in the direction of flow of the cooling fluid within the cooling passage, also get to receive flow of cooling fluid and thus are effectively cooled.

### SUMMARY OF INVENTION

Thus an object of the present disclosure is to provide a turbomachine component having film cooling arrangement in which the cooling fluid flows also to the regions of the inner surface between the inlets of the film cooling holes and to the regions of the inner surface downstream of the inlets of the film cooling holes, when viewed in the direction of flow of the cooling fluid within the cooling passage.

The above objects are achieved by a turbomachine component having film cooling arrangement for a gas turbine engine, a turbine blade/vane and a turbine blade/vane according to the present technique. Advantageous embodiments of the present technique are provided in dependent claims.

In a first aspect of the present technique, a turbomachine component having film cooling arrangement for a gas turbine engine is presented. The turbomachine component includes a cooling passage, an external wall, a plurality of film cooling holes, and a flow guide arrangement. The cooling passage is defined within the turbomachine component. The external wall of the turbomachine component includes an outer surface adapted to be positioned in a hot gas path of the gas turbine engine and an inner surface that forms a part of the cooling passage. The film cooling holes are formed through the external wall of the turbomachine component and are positioned spaced apart over at least part of the external wall. Each of the film cooling holes has an inlet and an outlet. The inlet is positioned on the inner surface of the external wall in the cooling passage and is adapted to receive a cooling fluid flowing through the cooling passage and to direct the cooling fluid towards the outlet. The outlet is positioned on the outer surface of the external wall and is adapted to release the cooling fluid over the outer surface of the external wall to form a cooling film over at least a part of the outer surface of the external wall.

The flow guide arrangement includes one or more flow guides. Each of the flow guides corresponds to one of the film cooling holes i.e. one flow guide corresponds to at least one film cooling hole, and advantageously corresponds to a unique film cooling hole. The flow guide is positioned at the inlet of the corresponding film cooling hole and on the inner surface of the external wall of the turbomachine component. The flow guide redirects a flow of the cooling fluid within the cooling passage such that the flow of the cooling fluid makes a U-turn within the cooling passage before being received by the inlet of the corresponding film cooling hole. The cooling fluid enters the inlet of the corresponding film cooling hole in a reversed flow.

Thus, due to the flow guide, the cooling fluid is redirected to flow over a region of the inner surface forming sides of the inlet of the corresponding film cooling hole and to a region of the inner surface that is downstream of the inlet of the corresponding film cooling hole when viewed following a flow path of the cooling fluid from entry into the cooling passage, say from some external source of the cooling fluid or inlet of the cooling passage, and continuing towards the inlet of the corresponding film cooling hole. Thus as a result of redirection of the flow of the cooling fluid achieved by the flow guide, the region of the inner surface forming the sides of the inlet of the corresponding film cooling hole and the region of the inner surface downstream of the inlet of the corresponding film cooling hole are cooled.

In an embodiment of the turbomachine component, the flow guide includes a closed end side and an open end side. The flow guide surrounds the inlet of the corresponding film cooling hole such that the close end side faces the flow of the cooling fluid flowing in the cooling passage before the cooling fluid makes the U-turn in the cooling passage. The closed end side blocks the inlet from receiving the flow of the cooling fluid flowing in the cooling passage before the cooling fluid makes the U-turn in the cooling passage. The open end side is adapted to face away from the flow of the cooling fluid flowing in the cooling passage before the cooling fluid makes the U-turn in the cooling passage. The open end side allows the inlet to receive the flow of the cooling fluid flowing in the cooling passage after the cooling fluid makes the U-turn in the cooling passage. This provides a structure for the implementation of the flow guide.

The flow guide may have various shapes or designs such as the flow guide may be horseshoe shaped structure having a curved side forming the close end side and an open arms side forming the open end side; or may be a U-shaped structure having a curved side forming the close end side and an open arms side forming the open end side wherein the open arms side comprises two open arms parallel to each other; or may be a U-shaped structure having a straight side forming the close end side and an open arms side forming the open end side wherein the open arms side comprises two open arms parallel to each other; or may be a V-shaped structure having a curved side forming the close end side and an open arms side forming the open end side. These different shapes of the flow guide provide different options of implementation designs for the flow guide depending on a space where the flow guide is to be located and on a desired redirecting of the cooling fluid to be achieved by the flow guide.

In another embodiment of the turbomachine component, the turbomachine component includes an impingement surface positioned downstream of the flow guide when viewed along a direction of the flow of the cooling fluid flowing in the cooling passage before the cooling fluid makes the U-turn in the cooling passage. The open end side of the flow guide is positioned facing the impingement surface. The impingement surface blocks the flow of the cooling fluid flowing in the cooling passage before the cooling fluid makes the U-turn in the cooling passage and redirects the cooling fluid towards the open end side of the flow guide. The impingement surface may be a part of the inner surface of the external wall of the turbomachine component, or may be a surface of a structure, such a rib, extending from the inner surface of the external wall of the turbomachine component. In a related embodiment the impingement surface has a wavy contour. The impingement surface actively blocks the flow of the cooling fluid flowing in the cooling passage before the cooling fluid makes the U-turn in the cooling passage and thus aids the open end side of the flow guide in receiving the cooling fluid.

In another embodiment of the turbomachine component, the flow guide includes one or more upstream fins positioned at the closed end side of the flow guide. The upstream fins divide the flow of the cooling fluid before the cooling fluid makes the U-turn in the cooling passage and thus aid in redirecting the cooling flow of the cooling fluid. These upstream fins form a smooth streamlined surface to reduce any sharp changes in flow velocity and accordingly reduce any pressure losses associated with abrupt changes in cooling flow velocity.

In another embodiment of the turbomachine component, the turbomachine component includes at least a first flow guide and a second flow guide. The first flow guide corresponds to a first film cooling hole and the second flow guide corresponds to a second film cooling hole. The first film cooling hole and the second film cooling hole are adjacent to each other. Thus a region of the inner surface of the external wall between the inlets of the adjacent holes is cooled by the cooling fluid.

In a second aspect of the present technique, a turbine blade/vane comprising an aerofoil is presented. The aerofoil is a turbomachine component as described hereinabove with respect to the first aspect of the present technique. In an embodiment of the turbine blade/vane, the flow guide is positioned adjacent to a surface of a rib of the aerofoil such that the flow of the cooling fluid before the cooling fluid makes the U-turn in the cooling passage is blocked by the surface of the rib.

In a third aspect of the present technique, a turbine blade/vane comprising a platform is presented. The platform is a turbomachine component as described hereinabove with respect to the first aspect of the present technique.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 shows part of a gas turbine engine in a sectional view and in which an exemplary embodiment of a turbomachine component of the present technique is incorporated;

FIG. 2 schematically illustrates a perspective view of an exemplary embodiment of the turbomachine component, for example a turbine blade or stationary nozzle guide vane, depicting a plurality of film cooling holes and wherein an exemplary embodiment of the present technique is incorporated;

FIG. 3 schematically illustrates a cross-sectional view of an aerofoil of the exemplary embodiment of the turbomachine component depicted in FIG. 2, in which an exemplary embodiment of the present technique is incorporated;

FIG. 4 schematically illustrates an inner surface of an external wall of the aerofoil of FIGS. 2 and 3 and portraying a conventionally known film cooling holes arrangement and its functioning;

FIG. 5 schematically illustrates an inner surface of an external wall of the aerofoil of FIGS. 2 and 3 and portraying an exemplary embodiment of a flow guide arrangement of the present technique and its functioning;

FIG. 6 schematically illustrates an inner surface of an external wall of the aerofoil of FIGS. 2 and 3 and portraying a conventionally known film cooling holes arrangement having two adjacent film cooling holes and its functioning;

FIG. 7 schematically illustrates an inner surface of an external wall of the aerofoil of FIGS. 2 and 3 and portraying a film cooling holes arrangement having two adjacent film cooling holes and related flow guide arrangement of the present technique and its functioning;

FIG. 8 schematically illustrates section of an exemplary embodiment of a flow guide corresponding to a film cooling hole in accordance with the present technique;

FIG. 9 schematically illustrates an exemplary embodiment of the flow guide having a horseshoe shape;

FIG. 10 schematically illustrates an exemplary embodiment of the flow guide having a U-shape;

FIG. 11 schematically illustrates another exemplary embodiment of the flow guide having a U-shape; and

FIG. 12 schematically illustrates an exemplary embodiment of the flow guide having a V-shape; in accordance with aspects of the present technique.

### DETAILED DESCRIPTION OF INVENTION

Hereinafter, above-mentioned and other features of the present technique are described in details. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

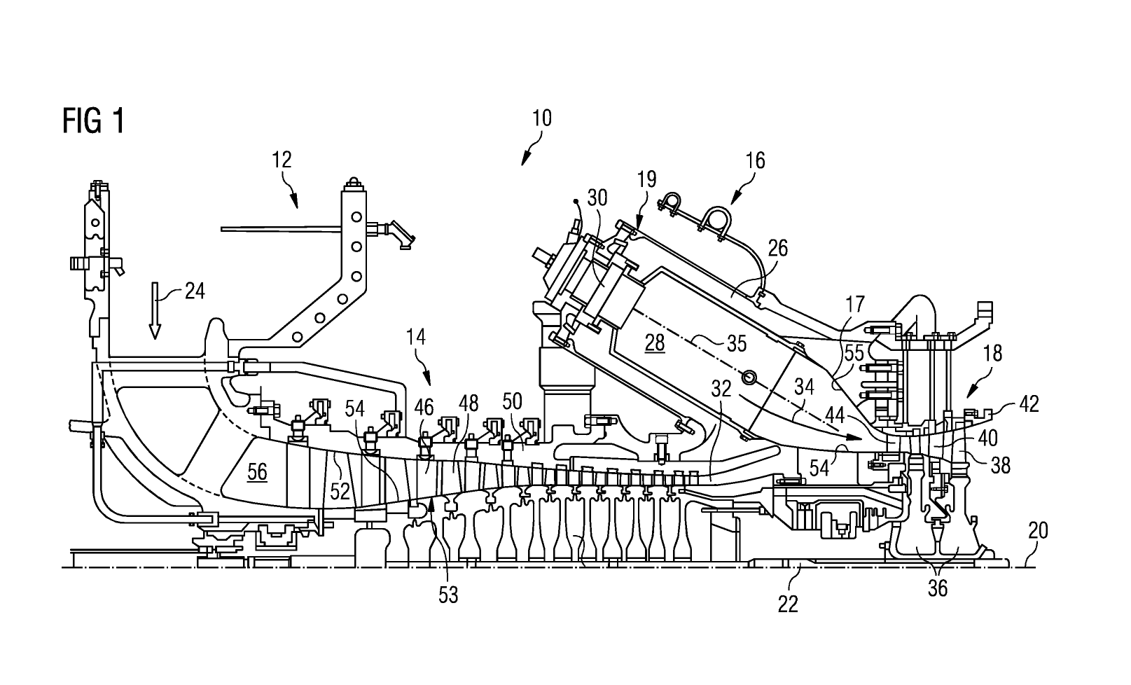

FIG. 1 shows an example of a gas turbine engine 10 in a sectional view. The gas turbine engine 10 comprises, in flow series, an inlet 12, a compressor or compressor section 14, a combustor section 16 and a turbine section 18 which are generally arranged in flow series and generally about and in the direction of a rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 extending along a longitudinal axis 35 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas 34 from the combustion chamber 28 enters the turbine section 18 and drives the turbine blades 38 which in turn rotate the shaft 22. The guiding vanes 40, 44 serve to optimise the angle of the combustion or working gas 34 on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present technique is described with reference to the above exemplary turbine engine having a single shaft or spool connecting a single, multi-stage compressor and a single, one or more stage turbine. However, it should be appreciated that the present technique is equally applicable to two or three shaft engines and which can be used for industrial, aero or marine applications. Furthermore, the cannular combustor section arrangement 16 is also used for exemplary purposes and it should be appreciated that the present technique is equally applicable to annular type and can type combustion chambers.

The terms upstream and downstream refer to the predominant flow direction of a cooling air flow in a given component unless otherwise stated. The terms axial, radial and circumferential are made with reference to the rotational axis 20 of the engine, unless otherwise stated.

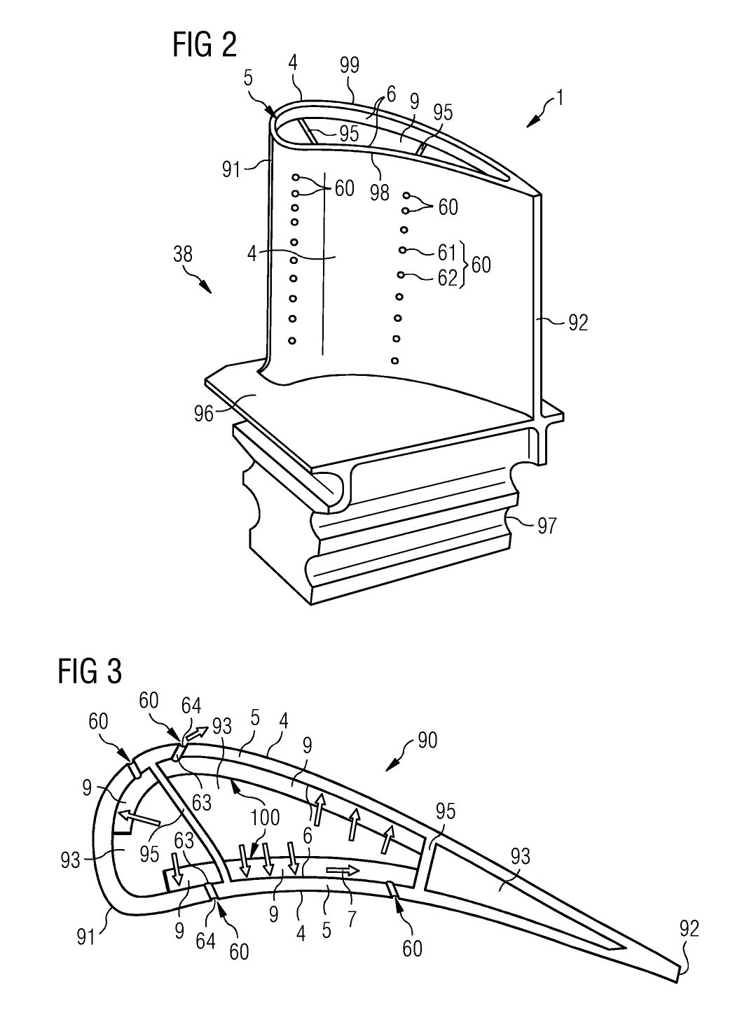

FIG. 2 schematically illustrates a turbomachine component 1, which in the exemplary embodiment of FIG. 2 is the aerofoil 90, and FIG. 3 schematically illustrates a cross-section of the aerofoil 90. Examples of the turbomachine component 1 are the turbine blade 38 or the vane 40 or the inlet guiding vane 44 of FIG. 1 or any component parts of the turbine blade 38 or the vane 40 or the inlet guiding vane 44, for example the aerofoil 90 may itself be the turbomachine component 1. It may be noted that the present technique has been explained in details with respect to an exemplary embodiment of the turbomachine component 1 wherein the turbomachine component 1 is the aerofoil 90 of the turbine blade 38 or the vane 40 or the inlet guiding vane 44, however, it must be appreciated that the present technique is equally applicable and implemented similarly in another embodiment of the turbomachine component 1 wherein the turbomachine component 1 is a platform 96 of the guiding vane 40, 44 or the turbine blade 38 or wherein the turbomachine component 1 is any other component of the gas turbine engine 10 that has a film cooling arrangement with film cooling holes spaced apart over an external wall of the component 1, for example the turbomachine component 1 may be a double skin section of a combustion chamber 28 or transition duct 17, interduct or stator shroud.

In the blade 38, the aerofoil 90 extends from a platform 96 in a radial direction. The platform 96 extends circumferentially. Also from the platform 96 emanates a root 97 or a fixing part 97. The root 8 or the fixing part 8 may be used to attach the blade 1 to the turbine disc 36 (shown in FIG. 1).

The aerofoil 90 includes an external wall 5 having an outer surface 6 and an inner surface 6. The aerofoil 90 has a suction side 98 and a pressure side 99 that together form or meet at a trailing edge 92 on one end and a leading edge 91 on another end. The external wall 5 forms the sides 98, 99 and the edges 91, 92.

The aerofoil 90 has a cooling passage 9 defined within the turbomachine component 1 as shown in FIG. 3. The cooling passage 9 may include one or more cooling passages or channels that may be fluidly distinct from each other or connected to each other. The cooling passage 9 may be defined by an impingement plate 100 or tube 100 arranged along sections of the inner surface 6 of the external wall 5, as shown in FIG. 3 that confines the cooling flow in the cooling passage 9. As mentioned earlier, applications of the present technique include, but not limited to, a double skin section of a combustion chamber 28 or transition duct 17 (shown in FIG. 1) wherein the space between the skins forms the cooling passage 9. The cooling fluid for example cooling air flows into the cooling passage 9 for example from an aerofoil cavity 93 or may flow into the cooling passage 9 from a connecting cooling channel (not shown) that brings cooling air into the cooling passage 9 from an cooling air source external to the aerofoil 90. The external wall 5 of the aerofoil 90 has an outer surface 4 and an inner surface 6. The outer surface 4 is positioned in a hot gas path of the gas turbine engine 10 when the aerofoil 90 is present inside the gas turbine engine 10 in operational mode. The inner surface 6 forming a part of the cooling passage 9 as shown in FIG. 3. From the inner surface 6 of the external wall 5 may arise different other structural features of the aerofoil 90 for example ribs 95.

In the aerofoil 90, a plurality of film cooling holes 60 are formed through the external wall 5. The film cooling holes 60 are present spaced apart over at least a part of the external wall 5 as shown in FIG. 2. FIG. 2 also depicts two adjacently positioned film cooling holes 60; say a first film cooling 61 and a second film cooling hole 62. The depiction of the two adjacently positioned film cooling holes 61 and 62 is only for identification and representative, any two adjacently positioned film cooling holes can be the first and the second film cooling holes 61, 62.

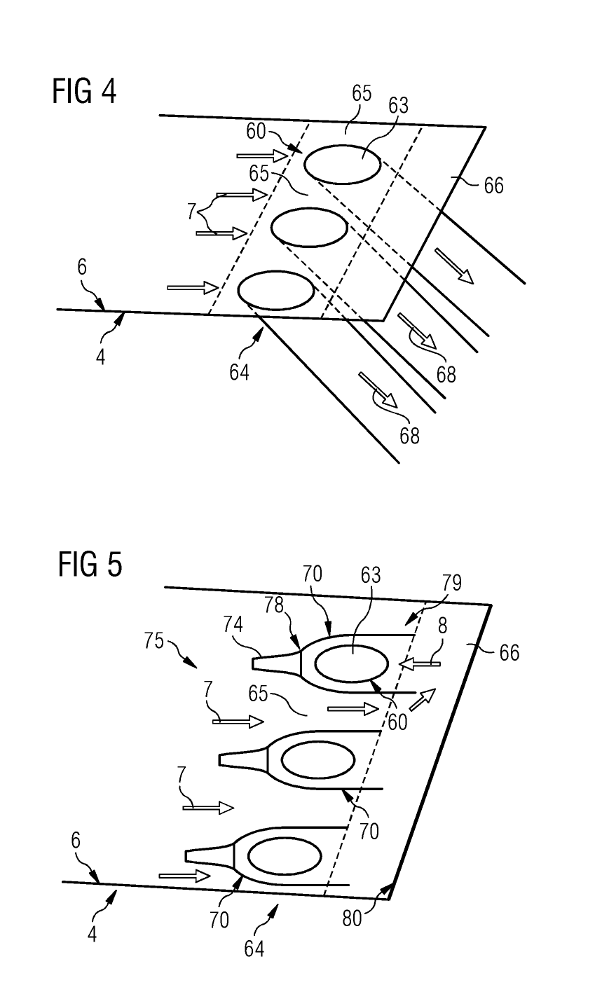

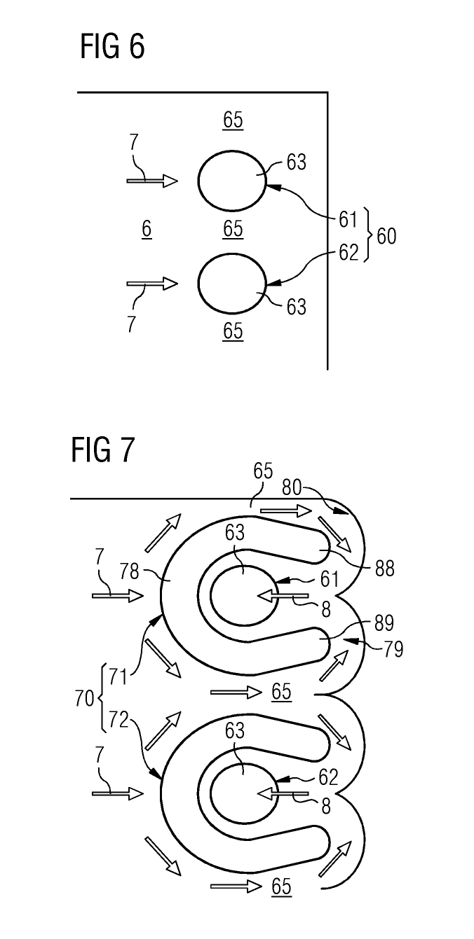

As shown in FIG. 3, each of the film cooling holes 60 has an inlet 63 and an outlet 64. The inlet 63 is positioned on the inner surface 6 of the external wall 5 in the cooling passage 9. The inlet 63 receives the cooling fluid flowing through the cooling passage 9. The cooling fluid after entering the inlet 63 flows through the film cooling hole 60 running through the external wall 5 and flows out of the film cooling hole 60 via the outlet 64 that is positioned on the outer surface 4 of the external wall 5. The cooling air flowing out of the outlet 64 spreads over the outer surface 4 of the external wall 5 to form a cooling film (not shown) over at least a part of the outer surface 4 of the external wall 5. The present technique includes introduction of structural features on the inner surface 6 of the external wall 5, which has been explained hereinafter with reference to FIGS. 4 to 7, especially for comparative understanding FIGS. 4 and 6 schematically depict the inner surface 6 without the structural features of the present technique whereas FIGS. 5 and 7, respectively in contrast to FIGS. 4 and 6, schematically depict the inner surface 6 with the structural features of the present technique.

As shown in FIG. 4, the cooling air flowing over the inner surface 6 that forms a wall or floor of the cooling passage 9 flows into the inlet 63 and then out of the outlet 64 of the film cooling holes 60 in form of flow exit 68. None or insignificant amount of the cooling air or the flow 7 of the cooling air flows over regions 65 of the inner surface 6 that form sides of the inlet 63 and/or area of the inner surface 6 between two adjacent film cooling holes. Similarly, none or insignificant amount of the cooling air or the flow 7 of the cooling air flows to and over a section 66 of the inner surface 6. Thereby, the sections 65 and/or section 66 are not adequately cooled. However, as shown in FIG. 5, in accordance with aspects of the present technique, structural features are introduced on the inner surface 6 of the external wall 5. The aerofoil 90 has a flow guide arrangement 75 having at least one flow guide 70 which is the structural feature of the present technique that is introduced on the inner surface 6 of the external wall 5. Each flow guide 70 corresponds to one of the film cooling holes 60 i.e. function of each flow guide 70 is associated with at least one of the film cooling holes 60 and advantageously with a unique film cooling hole 60 as depicted in FIG. 5.

The flow guide 70 is positioned at the inlet 63 of the corresponding film cooling hole 60 on the inner surface 6 i.e. the flow guide 70 is positioned in close vicinity of the inlet 63 of the corresponding film cooling hole 60 on the inner surface 6, for example the flow guide 70 is arranged about the inlet 63 or around the inlet 63 or surrounding the inlet 63 on the inner surface 6 but not blocking or closing the inlet 63 so as to disallow fluid flow of any form. As shown in FIG. 5, the flow guide 70 redirects the flow 7 of the cooling fluid within the cooling passage 9 such that the flow 7 of the cooling fluid makes a U-turn within the cooling passage 9. The cooling fluid enters the inlet 63 of the corresponding film cooling hole after, and advantageously only after, the cooling fluid has made the U-turn within the cooling passage 9. The flow 7 after making the U-turn is reversed in direction which is represented by a reverse flow 8. As a result of the flow guide 70 redirecting the flow 7 of the cooling air, the section 65 and the section 66 of the inner surface 6 of the external wall 5 and thereby cooling the section 65 and the section 66 of the inner surface 6 of the external wall 5.

Furthermore, as shown in FIG. 5, the flow guide 70 has a closed end side 78 and an open end side 79. The flow guide 70 surrounds the inlet 63 of the corresponding film cooling hole 60 such that the close end side 78 faces the flow 7 of the cooling fluid flowing in the cooling passage 9. The closed end side 78 function is to block the cooling air while in the flow 7 from entering the inlet, or in other words, the closed end side 78 functions to block the inlet 63 from receiving the flow 7 of the cooling fluid. The open end side 79 of the flow guide 70 faces away from the flow 7 of the cooling fluid flowing in the cooling passage 9 i.e. the open end side 79 of the flow guide 70 is arranged such that the flow 7 while continuing in its direction towards the inlet 63 cannot enter through the open end side 79. The open end side 79 of the flow guide 70 functions to allow the cooling air while in the reverse flow 8 to enter the inlet 63 through the open end side 79 or in other words the open end side 79 functions to allow the inlet 63 to receive the reverse flow 8 of the cooling fluid flowing in a direction opposite to the direction of the flow 7.

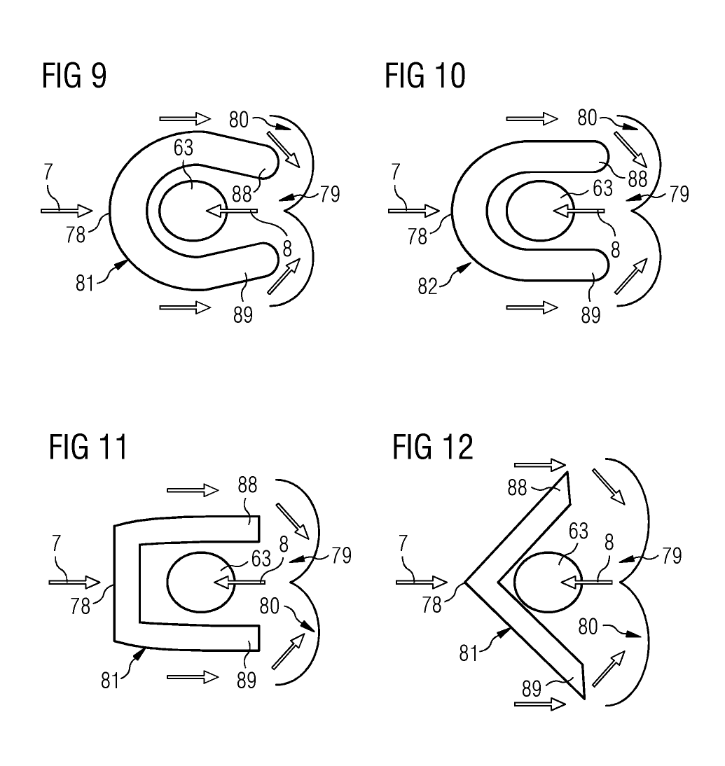

The flow guide 70 may have various shapes or designs. In an exemplary embodiment, as schematically shown in FIG. 9 the flow guide 70 may be horseshoe shaped structure 81 having a curved side forming the close end side 78 and an open arms side forming the open end side 79. As schematically shown in FIG. 10 in another exemplary embodiment, the flow guide 70 may be a U-shaped structure 82 having a curved side forming the close end side 78 and an open arms side forming the open end side 79. In this embodiment, the open arms side has two open arms 88, 89 substantially parallel to each other 88, 89. In another exemplary embodiment, as schematically shown in FIG. 11, the flow guide 70 may be the U-shaped structure 82 having a straight side forming the close end side 78 and an open arms side forming the open end side 79. In this embodiment, the open arms side has the two open arms 88, 89 substantially parallel to each other 88, 89. In yet another exemplary embodiment, as schematically depicted in FIG. 12, the flow guide 70 may be a V-shaped structure having a curved side forming the close end side 78 and an open arms side forming the open end side 79.

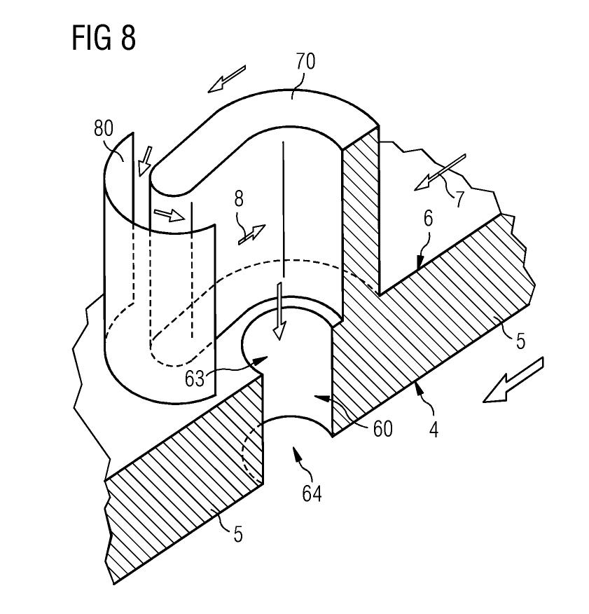

Referring again to FIG. 5, another exemplary embodiment of the aerofoil 1 is presented, having an impingement surface 80. The impingement surface 80 is positioned downstream of the flow guide 70 when viewed along the direction of the flow 7. The open end side 79 of the flow guide 70 is arranged close to and facing the impingement surface 80. The impingement surface 80 functions to block the flow 7. As a result of the blocking the cooling air turns back towards the open end side 79 of the flow guide 70. To further facilitate blocking and turning back of the cooling air the impingement surface 80 may have surface features such as a wavy surface as shown in FIGS. 9 to 12. The making of U-turn of the cooling air and thus attaining the reverse flow 8 from the flow 7 of the cooling air within the cooling passage 9 effected by the flow guide 70 and the impingement surface 80 is further schematically depicted in FIG. 8 which depicts a 3-dimensional view of a section of the flow guide 70 and the impingement surface 80.

In an exemplary embodiment (not shown), the impingement surface 80 is a part of the inner surface 6 of the external wall 5 for example when the inner surface 6 fold backs on itself. In another exemplary embodiment, the impingement surface 80 is a surface of a structure extending from the inner surface 6 of the external wall 5 of the aerofoil 60 for example surface of the ribs 95 shown in FIG. 3. In another exemplary embodiment, as shown in FIG. 8, the inner surface 80 is formed independently as a wall positioned in front of the open end side 79 of the flow guide 70.

Furthermore, as shown in FIG. 5, the flow guide 70 may include one or more upstream fins 74 positioned at the closed end side 78. The upstream fins 74 may be in form of plates arranged along the flow 7 and functioning to divide the flow 7 of the cooling fluid before the cooling fluid makes the U-turn in the cooling passage 9.

Referring to FIG. 7, in comparison with FIG. 6, the flow guide arrangement 75 with at least flow guides 70 namely a first flow guide 71 and a second flow guide 72 is shown. FIG. 6 schematically depicts the inner surface 6 and the inlets 63 of the first film cooling hole 61 and the second cooling hole 62, adjacent to each other as has been also shown in FIG. 2, but without the first flow guide 71 and the second flow guide 72. As shown in FIG. 7, the first flow guide 71 corresponds to the first film cooling hole 61 and the second flow guide 72 corresponds to the second film cooling hole 62. In this embodiment of the aerofoil 90 a unique flow guide 70, namely the first flow guide 71 corresponds to a unique film cooling hole 60 namely the first film cooling hole 61, whereas another unique flow guide 70, namely the second flow guide 72 corresponds to another unique film cooling hole 60 namely the second film cooling hole 61.

As shown in FIG. 7, in particular, the direction of flow 7 is in the plane of the inner surface 6. The arrows depicting flow 7 show the direction of the main or bulk flow of cooling fluid passing over the inner surface 6. The portion of the cooling fluid that is reversed flow 8 is turned approximately 180° in the plane of the inner surface such that the reversed flow 8 is travelling in the opposite direction to the flow 7. The film cooling hole(s) 61, 62 has a longitudinal axis or extent and which is generally perpendicular to the inner surface 6. Thus the cooling fluid is first flowing in the direction of flow 7 parallel to the inner surface 6, then it is turned in the plane of the inner surface as shown by flow 8 and then it is directed through the film cooling hole in a direction generally perpendicular to the inner surface or at least through the external wall 5. It should be appreciated that film cooling holes may be inclined to the perpendicular of the inner surface as is known in the art.

While the present technique has been described in detail with reference to certain embodiments, it should be appreciated that the present technique is not limited to those precise embodiments. It may be noted that, the use of the terms ‘first’, ‘second’, etc. does not denote any order of importance, but rather the terms ‘first’, ‘second’, etc. are used to distinguish one element from another. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A turbomachine component having film cooling arrangement for a gas turbine engine, the turbomachine component comprising:
a cooling passage defined within the turbomachine component;
an external wall of the turbomachine component, wherein the external wall comprises an outer surface adapted to be positioned in a hot gas path of the gas turbine engine and an inner surface forming a part of the cooling passage;
a plurality of film cooling holes formed through the external wall of the turbomachine component, the film cooling holes being spaced apart over at least a part of the external wall, wherein each of the film cooling holes has an inlet and an outlet, and wherein the inlet is positioned on the inner surface of the external wall in the cooling passage and is adapted to receive a cooling fluid flowing through the cooling passage and to direct the cooling fluid towards the outlet, and wherein the outlet is positioned on the outer surface of the external wall and is adapted to release the cooling fluid over the outer surface of the external wall to form a cooling film over at least a part of the outer surface of the external wall; and
a flow guide arrangement having at least one flow guide corresponding to one of the film cooling holes, the flow guide positioned at the inlet of the corresponding film cooling hole and on the inner surface of the external wall of the turbomachine component, and wherein the flow guide is adapted to redirect a flow of the cooling fluid within the cooling passage such that the flow of the cooling fluid makes a U-turn within the cooling passage before being received by the inlet of the corresponding film cooling hole and enters the corresponding film cooling hole in a reversed flow.

2. The turbomachine component according to claim 1,
wherein the flow guide comprises a closed end side and an open end side, and wherein the flow guide surrounds the inlet of the corresponding film cooling hole such that the close end side is adapted to face the flow of the cooling fluid flowing in the cooling passage before the cooling fluid makes the U-turn in the cooling passage and to block the inlet from receiving the flow of the cooling fluid flowing in the cooling passage before the cooling fluid makes the U-turn in the cooling passage, and wherein the open end side is adapted to face away from the flow of the cooling fluid flowing in the cooling passage before the cooling fluid makes the U-turn in the cooling passage and to allow the inlet to receive the flow of the cooling fluid flowing in the cooling passage in the reversed flow after the cooling fluid makes the U-turn in the cooling passage.

3. The turbomachine component according to claim 2,
wherein the flow guide is a horseshoe shaped structure having a curved side forming the close end side and an open arms side forming the open end side.

4. The turbomachine component according to claim 2,
wherein the flow guide is a U-shaped structure having a curved side forming the close end side and an open arms side forming the open end side wherein the open arms side comprises two open arms parallel to each other.

5. The turbomachine component according to claim 2,
wherein the flow guide is a U-shaped structure having a straight side forming the close end side and an open arms side forming the open end side wherein the open arms side comprises two open arms parallel to each other.

6. The turbomachine component according to claim 2,
wherein the flow guide is a V-shaped structure having a curved side forming the close end side and an open arms side forming the open end side.

7. The turbomachine component according to claim 2, further comprising:
an impingement surface positioned downstream of the flow guide when viewed along a direction of the flow of the cooling fluid flowing in the cooling passage before the cooling fluid makes the U-turn in the cooling passage and wherein the open end side of the flow guide is positioned facing the impingement surface, wherein the impingement surface is adapted to block the flow of the cooling fluid flowing in the cooling passage before the cooling fluid makes the U-turn in the cooling passage and to redirect the cooling fluid towards the open end side of the flow guide.

8. The turbomachine component according to claim 7,
wherein the impingement surface is a part of the inner surface of the external wall of the turbomachine component.

9. The turbomachine component according to claim 7,
wherein the impingement surface is a surface of a structure extending from the inner surface of the external wall of the turbomachine component.

10. The turbomachine component according to claim 7,
wherein the impingement surface has a wavy contour.

11. The turbomachine component according to claim 2,
wherein the flow guide further comprises one or more upstream fins positioned at the closed end side and adapted to divide the flow of the cooling fluid before the cooling fluid makes the U-turn in the cooling passage.

12. The turbomachine component according to claim 1, further comprising:
at least a first flow guide corresponding to a first film cooling hole and a second flow guide corresponding to a second film cooling hole and wherein the first film cooling hole and the second film cooling hole are adjacent to each other.

13. A turbine blade/vane comprising:
an aerofoil,
wherein the aerofoil is a turbomachine component according to claim 1.

14. The turbine blade/vane according to claim 13,
wherein in the aerofoil the flow guide is positioned adjacent to a surface of a rib of the aerofoil such that the flow of the cooling fluid before the cooling fluid makes the U-turn in the cooling passage is blocked by the surface of the rib.

15. A turbine blade/vane comprising:
a platform,
wherein the platform is a turbomachine component according to claim 1.
